(19) United States
(12) Patent Application Publication
(10) Pub. No.: US 2026/0356751 A1
(43) Pub. Date: Nov. 12, 2026

(54) HIGH STRENGTH AND DURABLE CHAR-BASED BRICKS AND METHODS OF MAKING CHAR-BASED BRICKS

(71) Applicant: UNIVERSITY OF WYOMING, Laramie, WY (US)

(72) Inventors: Kam Weng NG, Laramie, WY (US); Hua YU, Laramie, WY (US); Chooi Kim LAU, Laramie, WY (US); Sahul KHAREL, Laramie, WY (US)

(21) Appl. No.: 19/118,666

(22) PCT Filed: Oct. 5, 2023
(86) PCT No.: PCT/US2023/034528

§ 371 Date: Apr. 4, 2025

(51) Int. Cl. C04B 18/06; C04B 18/14; C04B 40/00; C04B 41/00; C04B 41/61; C04B 111/27; C04B 111/60

(52) U.S. Cl. CPC C04B 18/065; C04B 18/146; C04B 40/0071; C04B 40/0082; C04B 41/009; C04B 41/61; C04B 2111/27; C04B 2111/60; C04B 2201/20; C04B 2201/50

(57) ABSTRACT

Embodiments of the present disclosure relate to pyrolysis char bricks (PCBs) and methods of forming PCBs. The PCB includes a composition having a dry mixture and a wet mixture. The dry mixture includes pyrolysis char (PC) and cement materials. The wet mixture includes water, silica fume (SF), and additives. The composition is about 20% to 40% of PC, about 20% to 60% cement materials, about 0.1% to 10% SF, and about 1% to 1.5% additives, by weight. The method of forming a PCB includes mixing water and additives to form a wet mixture; mixing pyrolysis char (PC) and cement materials to form a dry mixture; mixing the wet mixture and the dry mixture to form a pyrolysis char brick (PCB) mixture; transferring the PCB mixture to a mold; pre-pressing the PCB mixture; initially curing the PCB mixture to for a PCB; demolding the PCB; and curing the PCB.

### BACKGROUND

### Field

Embodiments of the present disclosure generally relate to structural materials. In particular, the disclosure relates to pyrolysis char bricks (PCBs) and methods of fabricating PCBs.

### Description of the Related Art

Coal currently serves an important role as an energy source. However, an increasing demand for renewable energy has reduced the production and consumption of coal in the United States of America (USA). Coal is carbon-rich, and its use in energy generation may affect atmospheric CO₂ levels. The air pollution and global environmental issues associated with the combustion of coal have limited the continuous application of coal in energy production. Specifically, according to the Bureau of Safety and Environmental Enforcement (BSEE), global warming results from a various greenhouse gas emissions is partly due to fossil fuel burning, such as the combustion of coal. Therefore, several studies are being conducted to create new non-energy and fuel opportunities for Wyoming coal.

Wyoming is rated as one or the major producers of coal in the USA. The Wyoming Powder River Basin (PRB) coal plays an important role in the Wyoming energy industry. However, renewable energy is slowly replacing the coal industry, causing the market price of coal to drop. Thus, to attract new investment through technological innovation and support coal mine operations, environmentally friendly methods to create new diversified coal products are needed. One concern is characterizing the eco-efficiency of char products, which includes life-cycle metrics. In addition, the worldwide demand for bricks is rising, and is currently producing about 1,391 billion units. However, eco-friendly bricks suffer from various setbacks when comparing performance metrics to conventional clay bricks.

Therefore, there is a need for improved bricks derived from coal and methods of fabrication thereof.

### SUMMARY

In one embodiment, a pyrolysis char brick (PCB) is disclosed. The PCB includes a composition. The composition includes a dry mixture and a wet mixture. The dry mixture includes pyrolysis char (PC) and cement materials. The wet mixture includes water, silica fume (SF); and additives. The composition is about 20% to about 40% of PC, about 20% to about 60% cement materials, about 0.1% to about 10% SF, and about 1% to about 1.5% additives, by weight.

In another embodiment, a pyrolysis char block paver (PCBP) is disclosed. The PCBP includes a composition. The composition includes a dry mixture and a wet mixture. The dry mixture includes pyrolysis char (PC) and cement materials. The wet mixture includes water, silica fume (SF), and additives. The composition is about 25% to about 35% of PC, about 20% to about 60% cement materials, about 0.1% to about 10% SF, and about 1% to about 1.5% additives, by weight.

In yet another embodiment, a method of forming a PCB is disclosed. The method includes mixing water and additives to form a wet mixture; mixing pyrolysis char (PC) and cement materials to form a dry mixture; mixing the wet mixture and the dry mixture to form a pyrolysis char brick (PCB) mixture; transferring the PCB mixture to a mold; pre-pressing the PCB mixture; initially curing the PCB mixture to for a PCB; demolding the PCB; and curing the PCB.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates a flow diagram of a method of forming pyrolysis char bricks (PCBs), according to embodiments of the disclosure.

FIG. 2A is a graph illustrating the densities of PCBs with a water/(PC+binder) mass ratios of 0.39, according to embodiments of the disclosure.

FIG. 2B is a graph illustrating of cubic char specimens for water/(PC+binder) mass ratios of 0.45, according to embodiments of the disclosure.

FIG. 3A is a graph illustrating the compressive strengths of PCB samples for water/(PC+binder) mass ratios of 0.39, according to embodiments of the disclosure.

FIG. 3B is a graph illustrating the compressive strengths of PCB samples for water/(PC+binder) mass ratios of 0.45, according to embodiments of the disclosure.

FIG. 4 is a graph illustrating the densities of PCB samples with different additives, according to embodiments of the disclosure.

FIG. 5 is a graph illustrating the compressive strengths of PCB samples with different additives, according to embodiments of the disclosure.

FIG. 6A is a graph illustrating the water absorption percentage of PCB samples, according to embodiments of the disclosure.

FIG. 6B is a graph illustrating the water absorption saturation coefficient of PCB samples, according to embodiments of the disclosure.

FIG. 7A is a graph illustrating the heat flow of the PCB mixture samples with a w/c ratio of 0.58, according to embodiments of the disclosure.

FIG. 7B is a graph illustrating the cumulative heat of the PCB mixture samples with a w/c ratio of 0.58, according to embodiments of the disclosure.

FIG. 7C is a graph illustrating the heat flow of the PCB mixture samples with a w/c ratio of 0.68, according to embodiments of the disclosure.

FIG. 7D is a graph illustrating the cumulative heat of the PCB mixture samples with a w/c ratio of 0.68, according to embodiments of the disclosure.

FIG. 8A is a graph illustrating the thermogravimetric (TG) curve and differential thermal (DT) curve for PCB samples cured at 7 days, according to embodiments of the disclosure.

FIG. 8B is a graph of illustrating the thermogravimetric (TG) curve and differential thermal (DT) curve for PCB samples cured at 28 days, according to embodiments of the disclosure.

FIG. 9A is a scanning electron microscope (SEM) micrograph of a G1-2b sample.

FIG. 9B is a SEM micrograph of a G1-2b-AE sample, according to embodiments of the disclosure.

FIG. 9C is a SEM micrograph of a G1-2b-GO sample, according to embodiments of the disclosure.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to structural materials. In particular, the disclosure relates to pyrolysis char bricks (PCBs) and methods of fabricating PCBs. In one embodiment, pyrolysis char bricks (PCBs) are disclosed. In another embodiment, pyrolysis char block pavers (PCBPs) are disclosed. In yet another embodiment, a method of forming PCBs is disclosed.

The inventors have found new and improved methods of fabricating char bricks and compositions for char bricks from raw coal by mixing pyrolysis char (PC) with additives to replace sand and improve physical properties. Briefly, raw coal is thermo-chemically converted to produce PC, and the resulting PC is then converted to PC bricks (PCBs).

The desire for environmentally-friendly materials, energy savings, and reduced energy consumption in building materials can be addressed by the building materials described herein. Building materials made with PC have reduced density, increased strength, reduced thermal conductivity, and increased insulative properties when compared to conventional materials, such as clay bricks. These materials, through recycling/reuse and decreasing the amount of energy usage in fabrication, further lessens the environmental impact of the PCBs.

The use of headings is for the purposes of convenience and does not limit the scope of the present disclosure. Embodiments described herein can be combined with other embodiments.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

### Compositions

Embodiments of the present disclosure generally relate to structural materials. In particular, the disclosure relates to pyrolysis char bricks (PCBs) and methods of fabricating PCBs.

A composition (e.g., a PCB) includes a dry mixture and a wet mixture. The dry mixture includes PC, binder, and additives. The wet mixture includes water and additives. The binder may include cement materials and silica fume (SF). The PCBs may include about 20% to about 40% of PC, about 20% to about 60% cement materials, about 0.1% to about 10% SF, and about 1% to about 1.5% additives, by weight. The wet mixture and dry mixture may be mixed together to form a PCB mixture. The water to PC ratio in the PCB mixture is from about 0.5 to about 1.5. The water to (PC+binder) ratio is from about 0.3 to about 0.5. The PCB mixture, when cured, may become the PCBs.

The PCBs have a compressive strength from about 5 MPa to about 60 MPa, such as about 35 MPA to about 55 MPa for PCBs with additives. The density of the PCBs is from about 1.0 g/cm³ to about 2.0 g/cm³, such as about 1.3 g/cm³ to about 1.6 g/cm³. The compressive strength of the PCBs with additives is greater than that of a conventional clay brick (about 10 MPa to about 35 MPa), making the PCBs suitable for construction applications.

In some embodiments, the PCBs may be treated with a hydrophobic coating. The treated PCBs have a water absorption percentage of less than about 5%, such as less than about 3%. The treated PCBs further have a saturation coefficient from about 0.4 to about 1.6, such as about 0.5 to about 0.8. The water absorption percentage and saturation coefficient of treated PCBs was less than that of ASTM C62 Grade Moderate Weathering (MW) brick and ASTM C62 Grade Severe Weathering (SW) brick, making it suitable for use in sever and moderate weather conditions.

The additives may include superplasticizers (SPs), air entraining (AE) agents, algae, graphene oxide (GO), or combinations therein. The SF may be amorphous micronized white silicon dioxide pozzolan, a densified SF (e.g., Trinic R-E-D 105WS, Trinic R-E-D 106 μm, Trinic Pozz Plus, Trinic Z3-95, DMI NanoPozz 100-D), or an undensified SF (e.g., Riteks microfume 106 μm). The GO may be in powder form. The algae may be in liquid form. SP may include polycarboxylic ether polymer (such as BASF Melflux), a polycarboxylate ether, a sulfonated naphthalene formaldehyde, a sulfonated melamine formaldehyde, a lignosulfate, an acrylic polymer, or combinations thereof. The AE agents include acrylic cement modifiers (e.g., Akona liquid), natural wood resins, vinsol resins, synthetic detergents, animal and vegetable fats and oils, water-soluble synthetic organic compounds, alkyl benzene sulfonates, or a combination thereof.

The cement materials may include ordinary Portland Cement Type I, ordinary Portland Cement Type II are defined using ASTM C150/C150M (ASTM 2022). Standard sand is defined using ASTM ASTM C33/C33M (ASTM 2018).

The PC may include about 75% to about 85% fixed carbon, about 10% to about 20% ash, about 1% to about 3% moisture, and about 0.5% to about 1.5% volatile matter. The PC may be pyrolyzed at between about 800 °C and about 900 °C.

In some embodiments, the PCB is a PC block paver (PCBP) having a PC content of from about 25% to about 35%, such as about 30%. The chemical components of PC include fixed carbon (about 80.05%), ash (about 12.93%), moisture (about 7.02%), and volatile matter (about 0.0%). The dimensions of the PCBPs conform to ASTM C936. The density of the PCBPs is about 1.4 g/cm³ to about 1.7 g/cm³.

The PCBPs have a compressive strength between about 30 MPa and about 60 MPa, such as about 50 MPa to about 60 MPa. The water absorption of the PCBP is about 4% to about 6%, such as about 4.95%. The PCBPs had an average mass loss of about 15 g/m² to about 20 g/m² after the freeze thaw test. The abrasion value of the PCBPs was about 2 mm to about 3 mm, such as about 2.25 mm. The abraded volume was about 9 cm³ to about 13 cm³, such as about 10 cm³ to about 12 cm³, such as about 11.2 cm³.

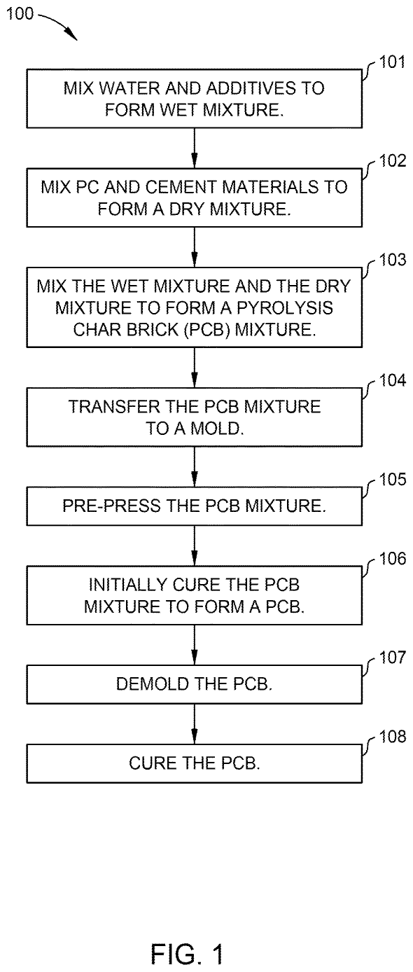

FIG. 1 illustrates a flow diagram of a method 100 of forming pyrolysis char bricks (PCBs). At operation 101, water and additives are mixed to form a wet mixture. The water and additive may be mixed for about 1 minute to about 10 minutes. The additives may include superplasticizer (SP), silica fume (SF), and graphene oxide (GO).

At operation 102, pyrolysis char (PC), cement materials, and sand are mixed to form a dry mixture. The PC, cement materials, and sand may be mixed for about 1 minutes to about 5 minutes.

At operation 103, the wet mixture is mixed with the dry mixture to form a PCB mixture. The PCB mixture includes about 20% to about 40% of PC, about 20% to about 60% cement materials, about 0.1% to about 10% SF, and about 1% to about 1.5% additives, by weight. The water to PC ratio in the PCB mixture is from about 0.5 to about 1.5. The water to (PC+binder) ratio is from about 0.3 to about 0.5. The wet mixture and the dry mixture may be mixed using a laboratory mixer. The wet mixture and the dry mixture may be mixed for about 1 minute to about 10 minutes.

At operation 104, the PCB mixture is transferred to molds. The molds may be metal molds in cubic or brick shape. At operation 105, the PCB mixture is pre-pressed in the mold. The pre-pressing may occur at a pressing pressure of about 4 MPa to about 10 MPa for about 30 seconds to about 3 minutes.

At operation 106, the PCB mixture is initially cured to form a PCB. The PCB mixture may be covered with a plastic membrane to prevent moisture loss while being initially cured. After 24 hours of being covered in the plastic membrane, the PCB mixture may be demolded before being initially cured. The PCB mixture may be placed into a wet room with a constant temperature of about 20 °C to about 30 °C and a relative humidity of about 90% to about 100%. The PCB mixture may be initially cured for about 5 to about 30 days. At operation 107, the PCBs are demolded.

At operation 108, the PCBs are transferred to the wet room with a constant temperature of 24 °C and relative humidity of 95% to further cure the PCBs. After reaching the designed curing time, e.g., 7, 14, 28 days, the density and compressive strength of PCBs are measured.

At optional operation 109, the PCBs are dried in an oven. The oven dried PCBs may have improved durability and reduced moisture absorption. The PCBs may be oven-dried at 50 °C to about 70 °C, such as about 60 °C, for about 20 hours to about 30 hours, such as about 24 hours. The temperature is set to prevent crystalline water loss in hydration products (e.g., ettringite), which may weaken the bonding between PC and hydration products, and reducing the strength of the PCBs.

At optional operation 110, the PCBs are coated in a hydrophobic coating liquid. The PCBs may be submerged in the hydrophobic coating liquid. During the submission, a vacuum pressure may be applied for about 20 hours to about 30 hours, such as about 24 hours. The vacuum pressure may enable the filling of pre-existed empty pores in PCBs with the hydrophobic coating liquid. The hydrophobic coating liquid may be a styrene acrylate material (e.g., BEHR PREMIUM Concrete & Masonry Protector & Waterproofer) with pH ranging from about 7 to about 10 and density of 0.99 g/cm³.

At optional operation 111, the PCBs are air-dried. The PCBs are air-dried for about 20 hours to about 30 hours, such as about 24 hours.

### Uses

Embodiments of the present disclosure also generally relates to sues of the compositions described herein. Compositions described herein can also be used for various applications.

Illustrative, but non-limiting, applications include concrete masonry units such as cinder blocks, breezeblocks, hollow blocks, concrete blocks, construction blocks, Besser blocks, clinker blocks, paver blocks, among other concrete masonry units.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used by some experimental errors and deviations should be accounted for.

### EXAMPLES

### Test Methods

The compressive strength of the PCBs was measured using a Forney compression machine. The compression strength of the PCBs was measured using ASTM C67.

The laboratory used for mixing is a stand mixer with a capacity of 7 quarts and maximum mixer speed of 900 rotations per minute.

Water absorption tests for the PCBs are performed in accordance with ASTM C67 (2021). The water absorption tests comprise 24 hours in cold water and 5 hours in boiling water. Freeze-thaw durability tests are performed in accordance with ASTM C67 (2021).

The water absorption tests for the PCBPs are performed in accordance with ASTM C1645. The desired water absorption is set in accordance with ASTM C936. The freeze thaw test was performed in accordance with ASTM C1645.

The scanning electron microscope (SEM) micrographs were made using FEI Quanta 250 SEM machine.

The abrasion test is performed in accordance with ASTM C418.

The thermogravimetric analysis and differential thermal analysis was performed using ASTM C1872. The thermogravimetric analysis was performed using TA Instruments Q500.

### EXPERIMENTAL

The pyrolysis char bricks (PCBs) in this disclosure are fabricated from PC produced using Powder River Basin (PRB) coal in Wyoming. The coal is pyrolyzed at a temperature of about 850 °C. The predominant chemical components of PC include fixed carbon (about 79.9%), ash (about 16%), moisture (about 2.9%), and volatile matter (about 1.2%). The PC bricks further include ordinary Portland cement type I & II referring to ASTM C150/C150M (ASTM 2022), standard sand referring to ASTM C33/C33M (ASTM 2018), silica fume (SF), black graphene oxide (GO) in powder form, algae (AG), superplasticizer (SP), and air entraining (AE) agent. The SF may be manufactured as RED 105 WS and may be amorphous micronized white silicon dioxide pozzolan. Black GO in powder form and AG in liquid form are manufactured at the University of Wyoming. However such materials are available from other commercial manufacturers. The SP is BASF Melflux 2651F in light yellowish powder form. The air entraining (AE) agent may be an Akona liquid air entraining admixture in liquid form with an amber color.

Table 1 shows a summary of the mixture design by weight percentage of the PCB samples. PCB samples having a water to (PC+binder) ratio of 0.39 were designated Group 1 (G1), while PCB samples having a water to (PC+binder) ratio of 0.45 were designated Group 2 (G2). The content of sand, SF, and water/cement ratio was varied throughout the various PCB samples. PC and SF in a fine powder may absorb a greater amount of water during the wet mixing process. The binder includes PC, cement materials, and SF. Water content may be reduced to improve the strength of the PCB. The additives (AE, AG, SF, and GO) may further improve the density and compressive strength of the PCBs.

TABLE 1
Summary of the Mixture Design (By Weight %) for PC Brick Samples.

| | | | | | | | water/ | |
|---|---|---|---|---|---|---|---|---|
| | | Char | Cement | Sand | SF | SP | (char + | |
| Group | Specimen | content | content | content | content | content | binder) | w/c |
| ID | ID | (%) | (%) | (%) | (%) | (%) | ratio | ratio |
| G1 | G1-0 | 40 | 58.8 | 0 | 0 | 1.2 | 0.39 | 0.66 |
| | G1-1 | 40 | 56 | 0 | 2.8 | 1.2 | 0.39 | 0.66 |
| | G1-2 | 40 | 53.5 | 0 | 5.3 | 1.2 | 0.39 | 0.66 |
| | G1-3 | 40 | 49 | 0 | 9.8 | 1.2 | 0.39 | 0.66 |
| | G1-4 | 40 | 28 | 29.4 | 1.4 | 1.2 | 0.39 | 0.92 |
| | G1-5 | 40 | 26.7 | 29.4 | 2.7 | 1.2 | 0.39 | 0.92 |
| | G1-6 | 40 | 24.5 | 29.4 | 4.9 | 1.2 | 0.39 | 0.92 |
| | G1-7 | 40 | 18.7 | 39.2 | 0.9 | 1.2 | 0.39 | 1.19 |
| | G1-8 | 40 | 17.8 | 39.2 | 1.8 | 1.2 | 0.39 | 1.19 |
| | G1-9 | 40 | 16.3 | 39.2 | 3.3 | 1.2 | 0.39 | 1.19 |
| G2 | G2-0 | 40 | 58.8 | 0 | 0 | 1.2 | 0.45 | 0.76 |
| | G2-1 | 40 | 56 | 0 | 2.8 | 1.2 | 0.45 | 0.76 |
| | G2-2 | 40 | 53.5 | 0 | 5.3 | 1.2 | 0.45 | 0.76 |
| | G2-3 | 40 | 49 | 0 | 9.8 | 1.2 | 0.45 | 0.76 |
| | G2-4 | 40 | 28 | 29.4 | 1.4 | 1.2 | 0.45 | 1.06 |
| | G2-5 | 40 | 26.7 | 29.4 | 2.7 | 1.2 | 0.45 | 1.06 |
| | G2-6 | 40 | 24.5 | 29.4 | 4.9 | 1.2 | 0.45 | 1.06 |
| | G2-7 | 40 | 18.7 | 39.2 | 0.9 | 1.2 | 0.45 | 1.37 |
| | G2-8 | 40 | 17.8 | 39.2 | 1.8 | 1.2 | 0.45 | 1.37 |
| | G2-9 | 40 | 16.3 | 39.2 | 3.3 | 1.2 | 0.45 | 1.37 |

In one experiment, the PCB samples are prepared using the pre-pressing method. Initially, water and additives are weighed and fully mixed for about five minutes to form the wet mixture. Dry PC, cement materials, and sand are weighed and mixed for about three minutes to form the dry mixture. The wet mixture is then added and mixed with the dry mixture using a laboratory mixer for about five minutes. After wet mixing, the mixture is transferred to metal molds (in cubic or brick shape). Then, the wet mixture is pre-pressed with a pressure of about 7 MPa for about 1 minute. After molding, all specimens are covered with plastic membrane to prevent moisture loss for initial curing. After 24 hours, all specimens are demolded and transferred to the wet room with a constant temperature of about 24 °C and relative humidity of about 95%. After reaching the designed curing time, the density and compressive strength of PCB samples are measured. The PCB samples are cured for about 7 days, about 14 days, and about 28 days.

The PCB samples are treated to reduce moisture absorption. First, the PCB samples are oven-dried at about 60 °C for about 24 hours. The temperature is set at about 60 °C to prevent crystalline water loss in hydration products (e.g., ettringite), weakening of the bonding between PC and hydration products, and reduction in the strength performance of char bricks. The oven-dried specimens are submerged in a hydrophobic coating liquid, and a vacuum pressure is applied for about 24 hours to facilitate the filling of pre-existed empty pores in PCBs with the hydrophobic coating liquid. The hydrophobic coating liquid may be BEHR PREMIUM Concrete & Masonry Protector & Waterproofer with pH ranging from about 7 to about 10 and density of about 0.99 g/cm³. The vacuum-coated PCBs are air-dried for about 24 hours before testing.

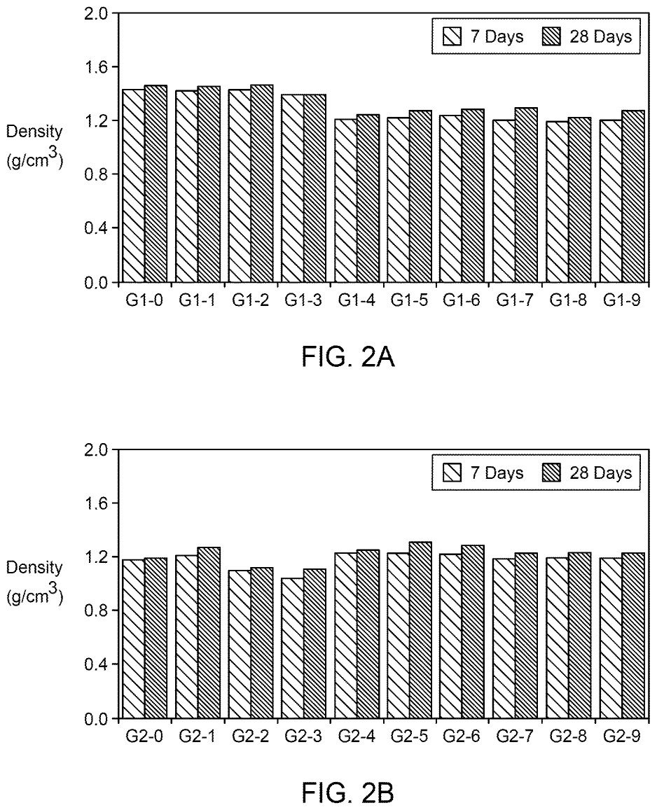

FIG. 2A is a graph illustrating the densities of PCBs with a water/(PC+binder) mass ratios of 0.39. FIG. 2B is a graph illustrating of PCBs for water/(PC+binder) mass ratios of 0.45. Increasing the curing time of the PCBs from 7 days to 28 days, regardless of water/(PC+binder) mass ratios or additions of sand and SF, may increase the density of the PCBs slightly (<8%). The increase may be due to newly formed hydration products in PCBs and water absorption from the wet room. The density of G1 PCBs ranges from about 1.19 g/cm³ to about 1.46 g/cm³. The density of G2 PCBs ranges from about 1.04 g/cm³ to about 1.31 g/cm³. The G1 PCBs may have a higher density due to the higher water content and lower content of solids in G2 specimens.

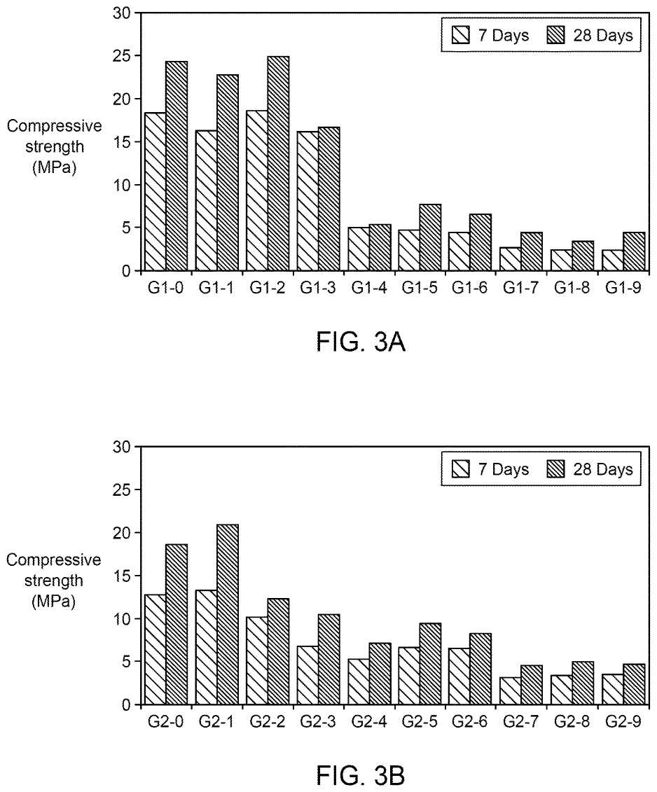

FIG. 3A is a graph illustrating the compressive strengths of PCB samples for water/(PC+binder) mass ratios of 0.39. FIG. 3B is a graph illustrating the compressive strengths of PCB samples for water/(PC+binder) mass ratios of 0.45. Increasing sand content to 39.2% decreases the compressive strength of specimens up to 82%. The higher sand content, which has non-binding characteristics, and lower cement material content may result in the lower compressive strength. The highest compressive strength of 25 MPa is observed in the G1-2 specimen. Increasing the water/(PC+binder) mass ratio may decrease the compressive strength. The compressive strength of G1-2 is only 2.4% higher than that of G1-0. The SF may benefit the PCB samples in terms of improved durability and elastic modulus.

Table 2 shows a summary of the mixture design of PCB samples with different additives. The mixture design of PCB sample G1-2b at a reduced w/c of 0.58 is comparable to that of cubic specimen G1-2. Using the mixture design of specimen G1-2b, the contents of AE, GO, and AG are set as 0.5% for PCB samples G1-2b-AE, G1-2b-GO, and G1-2b-AG, respectively. AE may improve workability of the PCB mixture, and can cause a reduction in the plastic viscosity of the PCB mixture. Increasing the AE content may cause a reduction in the w/c ratio, causing a lower w/c ratio for the G1-2b-AE PCB sample.

TABLE 2
Summary of the Mixture Design (By Weight %)
for PCB Samples with Different Additives

| | Char | Cement | SF | SP | AE | GO | AG | |
|---|---|---|---|---|---|---|---|---|
| Specimen | content | content | content | content | content | content | content | w/c |
| ID | (%) | (%) | (%) | (%) | (%) | (%) | (%) | ratio |
| G1-2b | 40 | 53.5 | 5.3 | 1.2 | 0 | 0 | 0 | 0.58 |
| G1-2b-AE | 40 | 53 | 5.3 | 1.2 | 0.5 | 0 | 0 | 0.57 |
| G1-2b-GO | 40 | 53.5 | 5.3 | 1.2 | 0 | 0.05 | 0 | 0.58 |
| G1-2b-ag | 40 | 53 | 5.3 | 1.2 | 0 | 0 | 0.5 | 0.54 |

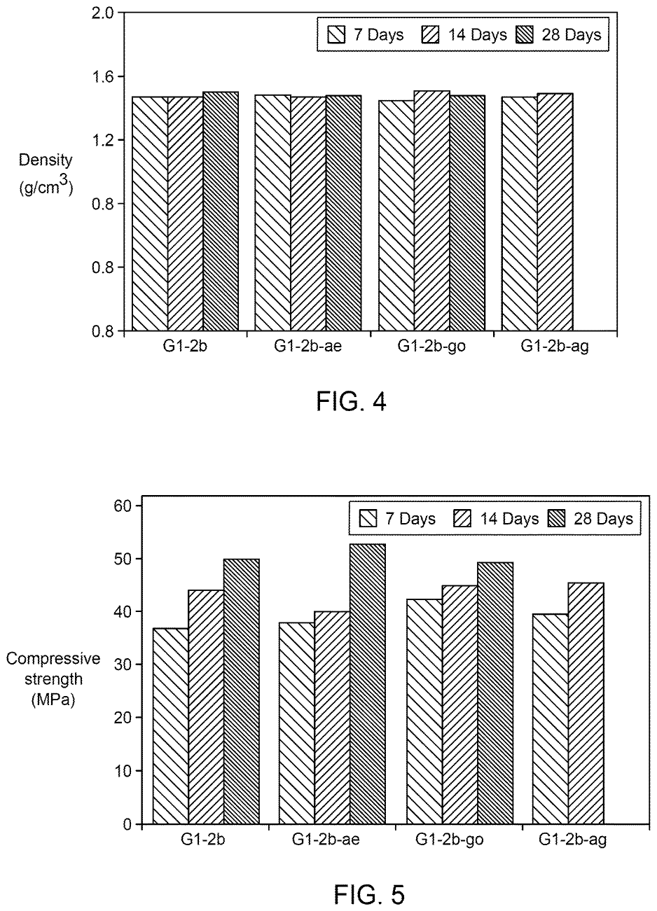

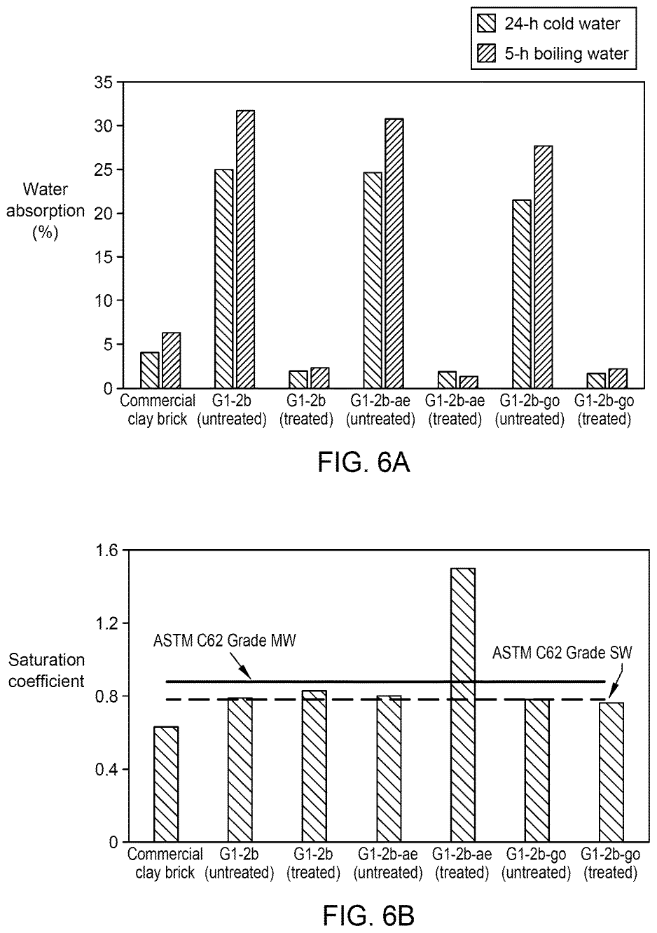

FIG. 4 is a graph illustrating the densities of PCB samples with different additives. FIG. 5 is a graph illustrating the compressive strengths of PCB samples with different additives. The densities of all PCB samples ranges between about 1.45 g/cm³ and 1.50 g/cm³. The effect of different additives on the density of PCBs may be limited. The compressive strength of conventional clay bricks (10-35 MPa) when tested in accordance with ASTM C62 (2017) and Indian Standard (IS)1077 (1992) is between about 10 MPa and about 35 MPa. All PCB samples cured for 28 days exhibit compressive strength 49.2 MPa. From the perspective of strength development of all PCB samples, unlike the negative effect of AE in concrete reported in past studies, specimen G1-2b-AE exhibits the highest compressive strength of 52.5 MPa. At 7 days, the compressive strengths of G1-2b-GO and G1-2b-AG are 14.6% and 9.2% higher, respectively, than that of G1-2b. However, as the curing time increases to 28 days, the compressive strengths of G1-2b-GO and G1-2b-AG become comparable to that of G1-2b. Both GO and AG may be helpful in developing the early compressive strength while the strength enhancement from GO and AG may diminish with increasing curing time.

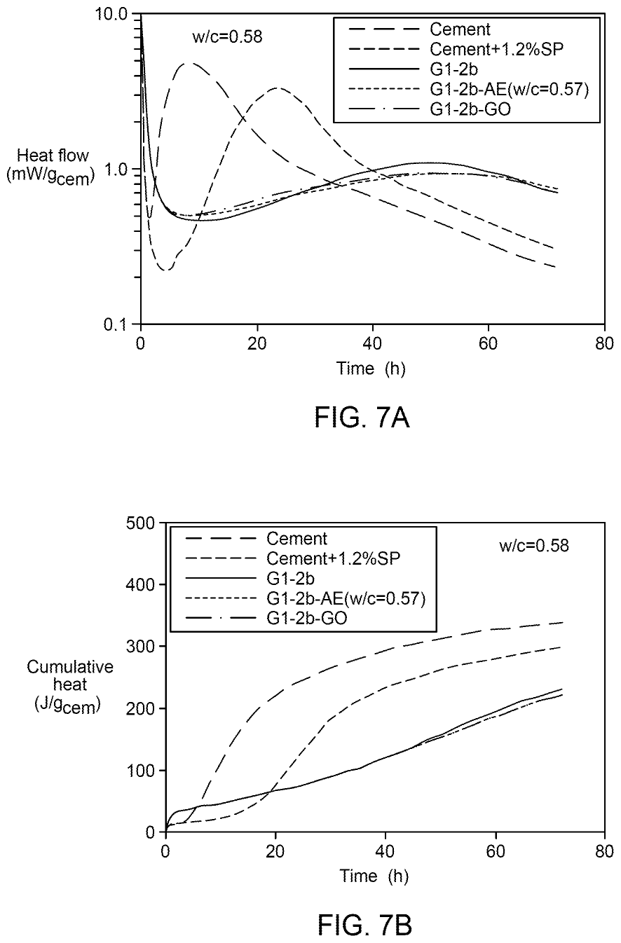

FIG. 6A is a graph illustrating the water absorption percentage of PCB samples. FIG. 6B is a graph illustrating the water absorption saturation coefficient of PCB samples. Table 3 is a summary of the water absorption results of PCB samples. For untreated PCBs, 24-h cold water absorptions range from about 21.5% to about 25%, which is higher than that of clay brick with 4% water absorption. The 5-h boiling water absorptions range from about 27.7% to about 31.7%, which is, on average, 75% higher than that of ASTM Grade SW brick and 36% higher than that of ASTM Grade MW brick. In contrast, the 5-h boiling water absorption of clay brick is only 6.3%, which is lower than the 17% for the ASTM Grade SW brick and 22% for the ASTM Grade MW brick. The saturation coefficient values are close to that of ASTM Grade SW brick.

For vacuum-treated PCB samples with hydrophobic coating liquid, regardless of different additives, both the 24-h cold water absorption and the 5-h boiling water absorption values are dramatically lower (>90%) than those of ASTM Grade SW brick, ASTM Grade MW brick and clay brick. For treated G1-2b-AE bricks, the saturation coefficient may be higher than one due to the 5-h boiling water absorption being relatively lower to the 24-h cold water absorption. No additional boiling water absorption and evaporation of pre-existing water occurred at high temperatures (e.g., about 92 °C) after the boiling test occurred.

TABLE 3
Summary of Water Absorption Results of PCB Samples.

| | 24-h cold | 5-h boiling | |
|---|---|---|---|
| | water | water | Saturation |
| Brick | absorption (%) | absorption (%) | coefficient |
| G1-2b (untreated) | 25 | 31.7 | 0.79 |
| G1-2b (treated) | 1.9 | 2.3 | 0.83 |
| G1-2b-ae (untreated) | 24.6 | 30.8 | 0.80 |
| G1-2b-ae (treated) | 1.8 | 1.2 | 1.50 |
| G1-2b-go (untreated) | 21.5 | 27.7 | 0.78 |
| G1-2b-go (treated) | 1.6 | 2.1 | 0.76 |
| ASTM C62 Grade SW | — | 17 | 0.78 |
| ASTM C62 Grade MW | — | 22 | 0.88 |
| Commercial clay brick | 4 | 6.3 | 0.63 |

Table 4 is a summary of the freeze-thaw (F-T) test results of the PCB samples. The vacuum treated G1-2b and G1-2b-AE experience more than 20 and 10 F-T cycles, respectively, without cracking. The PCBs performed better (10-20 cycles) than the commercial clay bricks, which cracked at 9 cycles.

TABLE 4
Summary of Freeze-Thaw Durability Test Results of PCB Samples

| | | | F-T cycles until |
|---|---|---|---|
| Brick | Char content (%) | Treatment | cracks observed |
| G1-2b | 40 | Treated | 20 |
| G1-2b-ae | 40 | Treated | 10 |
| Commercial clay brick | — | — | 9 |

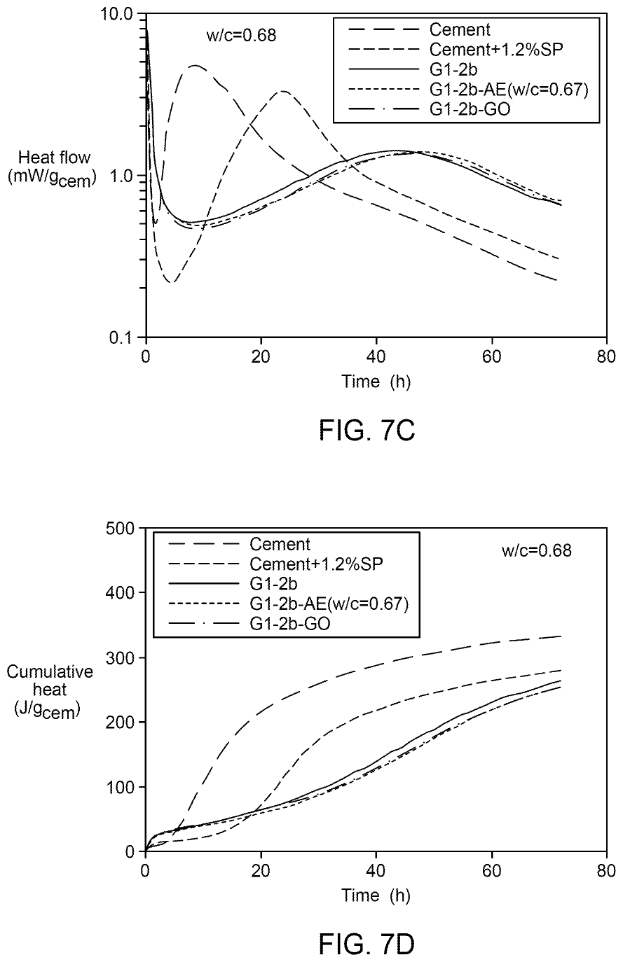

FIG. 7A is a graph illustrating the heat flow of the PCB mixture samples with a w/c ratio of 0.58. FIG. 7B is a graph illustrating the cumulative heat of the PCB mixture samples with a w/c ratio of 0.58. The PCB mixture samples include a 0.58 w/c unmodified cement sample (Cement), a 0.58 w/c PCB mixture with superplasticizers sample (Cement+1.2% SP), a 0.58 w/c G1-2b sample, a 0.57 w/c G1-2b-AE sample, and a 0.58 w/c G1-2b-GO sample. A first heat flow peak for the 0.58 w/c unmodified cement sample occurs at about 8.5 hours. This first heat flow peak may be due to the initial hydration of tricalcium silicate (C₃S). The addition of 1.2% SP increases the first heat flow peak to about 23.8 hrs. This may be due to the polycarboxylate-based SP delaying the dissolution of C₃S, thus delaying the formation of portlandite and CSH. Adding 40% PC delays the first heat flow peak to about 51 hours. This addition of PC may enhance the cement material hydration reaction due to the filler effect and nucleation caused by the electrostatic force between negatively charged PC and positively charged particles of the cement material. The delay may also be due to the large amount of free water absorbed by porous PC due to capillary force and the gradual release of absorbed water during cement material hydration.

The cumulative heat of the 0.58 w/c G1-2b is 69% lower than the 0.58 w/c unmodified cement sample and 39% lower than the 0.58 w/c PCB mixture with superplasticizers sample. As the mixing time increases, the cumulative heat of G1-2b is 32% lower than that of 0.58 w/c unmodified cement sample and 22% lower than that of the 0.58 w/c PCB mixture with superplasticizers sample.

FIG. 7C is a graph illustrating the heat flow of the PCB mixture samples with a w/c ratio of 0.68. FIG. 7D is a graph illustrating the cumulative heat of the PCB mixture samples with a w/c ratio of 0.68. The PCB mixture samples include a 0.68 w/c unmodified cement sample (Cement), a 0.68 w/c PCB mixture with superplasticizers sample (Cement+1.2% SP), a 0.58 w/c G1-2b sample, a 0.68 w/c G1-2b-AE sample, and a 0.58 w/c G1-2b-GO sample. The first heat flow peaks are comparable lower for the 0.68 w/c PCB mixture samples are lower than the 0.58 w/c PCB mixture samples. The first heat flow peak for the 0.68 w/c G1-2b, 0.68 w/c G1-2b-AE, and 0.68 w/c G1-2b-GO samples are between 43 hrs and 47 hrs. The first heat flow peak of the 0.68 w/c G1-2b, 0.68 w/c G1-2b-AE, and 0.68 w/c G1-2b-GO samples occurs about 15% faster than the 0.58 w/c G1-2b, 0.58 w/c G1-2b-AE, and 0.58 w/c G1-2b-GO samples. The higher w/c ration, therefore, may accelerate the hydration reaction in the PCB matrix at the early period (<72 hrs). This may be due to the higher amount of free water in the mixture.

For the 0.58 w/c G1-2b-AE, 0.58 w/c G1-2b-GO, 0.68 w/c G1-2b-AE, and 0.68 w/c G1-2b-GO, the peak heat flow and cumulative hydration heats are longer and higher, respectively, that the 0.58 w/c G1-2b and 0.68 w/c G1-2b samples. This may be due to the surface surfactants in AE partially obstruct the topochemical reaction of cement materials and water molecules, delaying cement material hydration. The nucleation effect may increase the heat release from the hydration acceleration, while the dilution of major compounds in the cement materials may decrease heat release. This may be due to the compensation of the nucleation effect of GO in the PC-cement material matrix by a large number of PC particles serving as nuclei during the cement material hydration and the dominant dilution effect of GO.

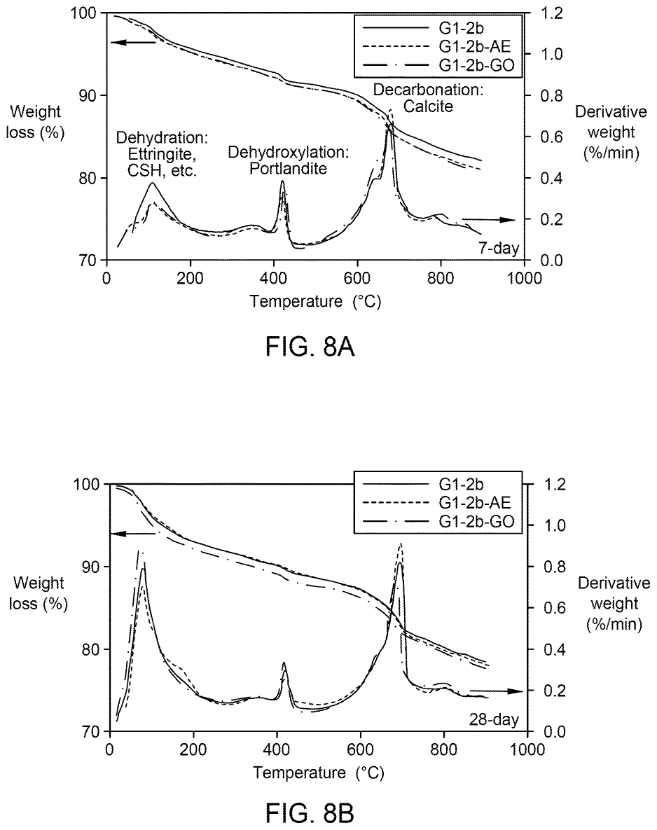

FIG. 8A is a graph illustrating the thermogravimetric (TG) curve and differential thermal (DT) curve for PCB samples cured at 7 days. FIG. 8B is a graph of illustrating the thermogravimetric (TG) curve and differential thermal (DT) curve for PCB samples cured at 28 days. The PCBs include G1-2b samples, G1-2b-AE samples, and G1-2b-GO samples. Three peaks may be observed for all PCB samples. The first peak may correspond to the dehydration of cement material hydration products at about 60 °C to about 350 °C. The second peak may correspond to the dehydroxylation of portlandite at about 400 °C to about 500 °C. The third peak may correspond to the decarbonation of calcite at about 600 °C to about 800 °C. The largest peak of the DT curve is typically observed in dehydration temperatures for unmodified cement. For PCB samples cured at 7 days, the largest peak attains at the decarbonation temperatures. This may be due the absorbed water in the porous structures of PC reducing the available amount of free water in the mixture, which may hinder the formation of hydration products due to the delay in the hydration reaction. It may also be due to the higher air containing C02 trapped in the porous PC during the mixing process.

The contents of physically and chemically bound water, portlandite (CH), and calcite contents can be estimated using Equations (1)-(3):

$$Bound Water Content = \frac{Δ {W}_{( 60 °C - 350 °C )}}{{W}_{t}} \times 100 \qquad ( 1 )$$

$$C H Content = \frac{Δ {W}_{( 400 °C - 500 °C )} {M}_{CH}}{{W}_{t} {M}_{{H}_{2} O}} \times 100 \qquad ( 2 )$$

$$Calcite Content = \frac{Δ {W}_{( 600 °C - 800 °C )} {M}_{Calcite}}{{W}_{t} {M}_{{CO}_{2}}} \times 100 \qquad ( 3 )$$

ΔW_{(60-350 °C)}, ΔW_{(400-500 °C)}, and ΔW_{(600-800 °C)} are the weight loss of the samples at 60-350 °C, 400-500 °C and 600-800 °C, respectively, from the TG results; Wₜ is the total weight of sample, M_{CH} is the molar mass of portlandite (74.09 g/mol), M_{calcite} is the molar mass of calcite (100.09 g/mol), M_{H}_{₂}_{O} is the molar mass of water (18.02 g/mol), and M_{CO}_{₂} is the molar mass of carbon dioxide (44.01 g/mol).

Table 5 is a summary of the compositions of PCB samples determined by the TG analysis. At 7 days, the bound water content of G1-2b-AE samples and G1-2b-GO samples are 1.7% and 3.4%, respectively, higher than that of G1-2b samples. The calcite contents of G1-2b-AE samples and G1-2b-GO samples are 5.4% and 7.5%, respectively, higher than that of G1-2b samples. The G1-2b-AE samples and G1-2b-GO samples may improve the early strength of the PCBs.

At 28 days, the calcite content of G1-2b-GO samples is 3% lower than that of the sample at 7 days. The G1-2b samples and G1-2b-AE samples do not exhibit this behavior. This may be due to the dissolution of calcite. The dissolution kinetics of calcite are related to pH, CO₂ pressure, and temperature. The G1-2b-GO samples may react with hydroxide ions in an alkaline solution and lose its oxygen-bearing groups, facilitating the dissolution of calcite with the reaction of Equation (4):

CaCO₃+H⁺=Ca²⁺+HCO₃⁻ (4)

TABLE 5
Summary of the Compositions of PCB
Samples Determined by TG Analysis.

| | | G1-2b | | G1-2b-AE | | G1-2b-GO | |
|---|---|---|---|---|---|---|---|
| Temperature | | 7 | 28 | 7 | 28 | 7 | 28 |
| range | Content | days | days | days | days | days | days |
| 60-350 °C | Bound water | 5.8 | 8.2 | 5.9 | 8.0 | 6.0 | 8.5 |
| | (ettringite, | | | | | | |
| | CSH, etc.) (%) | | | | | | |
| 400-500 °C | Portlandite (%) | 6.0 | 6.2 | 5.9 | 6.5 | 5.7 | 6.1 |
| 600-800 °C | Calcite (%) | 14.6 | 15.9 | 15.4 | 16.3 | 15.7 | 15.2 |

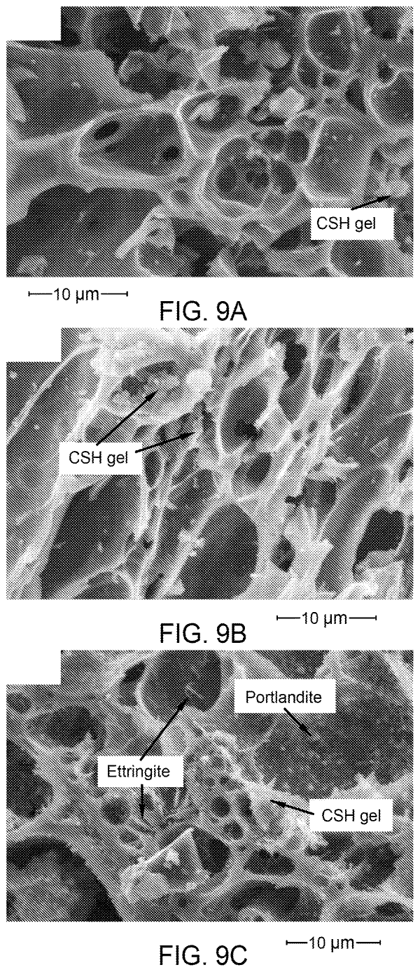

FIG. 9A is a scanning electron microscope (SEM) micrograph of a G1-2b sample. FIG. 9B is a SEM micrograph of a G1-2b-AE sample. FIG. 9C is a SEM micrograph of a G1-2b-GO sample. Few hydration products fill the porous PC in the G1-2b samples and G1-2b-AE samples. In contrast, the porous PC in G1-2b-GO samples are filled with hydration products. As the pyrolysis temperature increases, oxygen-containing functional groups on the PC surface decrease. The decrease in oxygen-containing functional groups (which may result in fewer hydrogen bonds to water molecules) of the PC pyrolyzed at 850 °C may lead to increased hydrophobicity. The hydrophobic surface of PC hinders the formation of hydration products on the surface or in the micropores of the PC. However, adding GO with the hydrophilic surface in a high pH environment (e.g., in hydrated cement materials) may form a GO film on the porous surface of the PC and may promote the filling of the micropores with hydration products.

Pyrolysis char block pavers (PCBPs) in this disclosure are fabricated from PC produced using Powder River Basin (PRB) coal in Wyoming. The coal is pyrolyzed at a temperature of about 850 °C. The predominant chemical components of PC include fixed carbon (about 80.05%), ash (about 12.93%), moisture (about 7.02%), and volatile matter (about 0.0%). The dimensions of the PCBPs conform to ASTM C936. The density of the PCBPs is about 1.4 g/cm³ to about 1.7 g/cm³.

The PCBP further include ordinary Portland cement type I & II referring to ASTM C150/C150M (ASTM 2022), silica fume (SF), black graphene oxide (GO) in powder form, algae (AG), superplasticizer (SP), and air entraining (AE) agent. The SF is a NanoPozz100-D, i.e. an amorphous micronized grey silicon dioxide pozzolana. The SP is a BASF Melflux 2651F in the form of a light yellowish powder. The AE is an Akona liquid air entraining agent with an amber color, which can be used to introduce air bubbles and improve workability, durability, and resistance to freezing and thawing in various construction applications.

Table 6 summarizes the mix design for the PCBP samples. The dry mixture including PC and cement materials is combined with water and additive (e.g., SP and SF) to form the PCBP mixture. The dry mixture and wet mixture are mixed for about 3 minutes. The PCBP mixture is placed into molds in three equal layers. Each layer is compacted using a tamping rod for about 15 to about 20 blows. The tamping may increase the compaction and densification of the PCBP mixture in the mold. The compacted PCBP mixture is transferred to a pressing machine. The pressing machine further increases compaction and densification.

Following pressing, the PCBP mixture is cured for about 1 day in to the PCBP. The PCBP is demolded from the mold and placed in a humidifying chamber to cure. The humidifying chamber may provide moisture to the PCBP. The PCBP is cured in the humidifying chamber for about 28 days. The cured PCBP is then coated with hydrophobic liquid. The PCBP is dipped in the hydrophobic liquid for about 24 hours under suction. The immersion of the PCBP in the hydrophobic liquid may increase the water resistance properties of the PCBP, as well as increase the freeze thaw durability.

TABLE 6
Mix Design for PCBP Samples.

| | | Cement | | | | |
|---|---|---|---|---|---|---|
| PCBP | PC | Material | | | | |
| Sample | content | Content | SF | SP | Additives | Note |
| C40-R | 40 | 53.50 | 5.30 | 1.2 | | R = Received |
| | | | | | | Char |
| C40-R-GF | 40 | 53.10 | 5.30 | 1.2 | 0.4% fiber | |
| C40-R-Na | 40 | 52.40 | 5.30 | 1.2 | 1.06% Na | |
| C40-R- | 40 | 52.10 | 5.30 | 1.2 | 1.06% Na, | |
| Na-AE | | | | | 0.3% AE | |
| C40-F-Na | 40 | 52.40 | 5.30 | 1.2 | 1.06% Na | F = Fine Char |
| C40-F- | 40 | 52.10 | 5.30 | 1.2 | 1.06% Na, | |
| Na-AE | | | | | 0.3% AE | |
| C40-F | 40 | 53.50 | 5.30 | 1.2 | | |
| S1-2F-FA | 40 | 37.55 | 5.30 | 1.2 | | S = Sand; FA = |
| | | | | | | Fine Aggregate |
| S1-2FO- | 40 | 37.96 | 5.30 | 1.2 | | FO = Silica |
| FA | | | | | | Fume |
| C40-FO | 40 | 53.40 | 5.30 | 1.2 | | |
| C40-WR | 40 | 53.50 | 5.30 | 1.2 | | WR = Wet |
| | | | | | | Room |
| C30-FO | 30 | 63.50 | 5.30 | 1.2 | | |
| C35-FO | 35 | 58.50 | 5.30 | 1.2 | | |

The PCBP samples include a 40% PC, 53.5% cement materials, 1.2% SP, and 5.3% SF sample (C40-R), a 40% PC, 53.1% cement materials, 1.2% SP, 5.3% SF, and 0.4% fiber sample (C40-R-GF), a 40% PC, 52.4% cement materials, 1.2% SP, 5.3% SF, and 1.06% sodium (Na) sample (C40-R-Na), a 40% PC, 52.1% cement materials, 1.2% SP, 5.3% SF, 1.06% sodium (Na), and 0.3% AE sample (C40-R-Na-AE), a 40% PC, 53.1% cement materials, a 40% PC, 52.4% cement materials, 1.2% SP, 5.3% SF, and 1.06% sodium (Na) sample (C40-F-Na), a 40% PC, 52.1% cement materials, 1.2% SP, 5.3% SF, 1.06% sodium (Na), and 0.3% AE sample (C40-F-Na-AE), a 40% PC, 52.4% cement materials, a 40% fine PC, 53.5% cement materials, 1.2% SP, and 5.3% SF sample (C40-F), a 40% PC, 37.55% cement materials, 1.2% SP, and 5.3% SF sample (S1-2F-FA), a 40% PC, 37.96% cement materials, 1.2% SP, and 5.3% SF sample (S1-2FO-FA), a 40% PC, 53.5% cement materials, 1.2% SP, and 5.3% SF sample (C40-FO), a 40% PC, 53.5% cement materials, 1.2% SP, and 5.3% SF sample (C40-WR), a 30% PC, 63.5% cement materials, 1.2% SP, and 5.3% SF sample (C30-FO), and a 35% PC, 58.5% cement materials, 1.2% SP, and 5.3% SF sample (C40-R). Fine PC is PC in which 98% of the PC particles are less than 300 microns. The PCBP samples have a water to binder ratio of 0.53, except for the S1-2F-FA and S1-2FO-FA samples which have a water to binder ratio of 0.45.

Table 7 shows the compressive strength of the PCBP samples. The C40-R PCBP ample had a compressive strength of 35.43 MPa. The C40-F PCBP sample had a compressive strength of 35.55 MPa, and the C40-FO has a compressive strength of 38.77 MPa. Thus, between the two curing techniques, the wet curing approach may have a higher strength than the PCBPs cured in the humidifying chamber. The C35-FO and C30-FO samples have the highest compressive strength. The C35-FO had a compressive strength of 44.15 MPa and the C30-FO had a compressive stress of 57.46 MPa.

TABLE 7
Compressive Strength of the PCBP Samples.

| | Compressive strength (MPa) | | |
|---|---|---|---|
| Mix-design | 7-day | 14-day | 28-day |
| C40-R | 28.95 | 31.67 | 35.43 |
| C40-R-GF | 29.11 | 28.53 | 32.04 |
| C40-R-Na | 23.95 | 35.23 | 37.55 |
| C40-R-Na-AE | 24.95 | 32.43 | 33.61 |
| C40-F-Na | 26.35 | 34.53 | 35.76 |
| C40-F-Na-AE | 28.27 | 34.58 | 34.77 |
| C40-F | 31.10 | 33.55 | 35.55 |
| S1-2F-FA | 37.12 | 37.55 | 39.36 |
| S1-2FO-FA | 35.12 | 37.96 | 39.23 |
| C40-FO | 34.36 | 38.60 | 38.77 |
| C40-WR | 28.72 | 36.83 | 38.81 |
| C30-FO | 48.95 | 54.10 | 57.46 |
| C35-FO | 35.76 | 39.84 | 44.15 |

Table 8 shows the freeze thaw test results. The water absorption test were conducted on the C30-FO samples. A total of three half-block paver samples were tested. The water absorption of the C30-FO samples was about 4.95%.

TABLE 8
Results of the Freeze Thaw Test.

| | | Water |
|---|---|---|
| Weight after 24 hrs of | Oven dry weight following | absorption |
| submersion in distilled water (g) | water submersion (g) | (%) |
| 798.0 | 763.3 | 4.54 |
| 694.2 | 661.9 | 4.87 |
| 664.8 | 630.4 | 5.45 |

| | |
|---|---|
| Average | 4.95 |

The freeze thaw was performed to test the ability of the PCBPs to resist crack formation due to extreme cold weather. The freeze thaw test was conducted on three C30-FO samples. A total of 28 cycles were carried out on the PCBP samples. Following the cycles, the residue collected was separated using a filter paper and oven dried. The ratio of the weight of the residue collected to the total surface area results in the average mass loss of the samples. The PCBPs had an average mass loss of about 18.68 g/m², which is within the acceptable limit of 225 g/m² as per ASTM C1645.

Table 9 shows the abrasion test results. The abrasion test was performed to characterize the PCBPs ability to perform under high abrasive forces, such as moving vehicles. The abrasion test was conducted on two C30-FO samples. The abrasion test was performed on 8 areas of the PCBP as per ASTM C418. A steel plate having a circular perforation at its center was used to expose the testing areas. The abrasion value of the PCBPs was about 11.2 cm³.

TABLE 9
Abrasion Test Results

| | | | | Equivalent | |
|---|---|---|---|---|---|
| | | | Abraded | abraded | |
| Initial | Final | | volume per | volume | Average |
| mass | mass | Mass of | 51.6 cm² area | per 50 cm² | thickness |
| (g) | (g) | clay (g) | (cm³) | area (cm³) | loss (mm) |
| 1463.20 | 1445.56 | 17.64 | 10.69 | 10.36 | 2.1 |
| 1606.55 | 1586.06 | 20.49 | 12.42 | 12.03 | 2.4 |

| | | |
|---|---|---|
| Average | 11.20 | 2.25 |

### EMBODIMENTS LISTING

Clause 1. A pyrolysis char brick (PCB), including:
a composition, the composition comprising:
   a dry mixture, comprising
      pyrolysis char (PC); and
      cement materials; and
   a wet mixture, comprising:
      water;
      silica fume (SF); and
      additives;
   wherein the composition is about 20% to about 40% of PC, about 20% to about 60% cement materials, about 0.1% to about 10% SF, and about 1% to about 1.5% additives, by weight.

Clause 2. The PCB of clause 1, wherein the composition has a water to PC ratio (w/c) of about 0.5 to about 1.5.

Clause 3. The PCB of clause 1, wherein the cement materials and SF form a binder, and wherein the composition has a PC to binder ratio of about 0.3 to about 0.5.

Clause 4. The PCB of clause 1, wherein the PCB has a compressive strength of about 35 MPA to about 55 MPa.

Clause 5. The PCB of clause 1, wherein the PCB has a density of about 1.0 g/cm³ to about 2.0 g/cm³.

Clause 6. The PCB of clause 1, wherein the PCB has a water absorption percentage of less than about 5%.

Clause 7. The PCB of clause 1, wherein the PCB has a saturation coefficient from about 0.4 to about 1.6.

Clause 8. The PCB of clause 1, wherein SF comprises amorphous micronized white silicon dioxide pozzolan, a densified SF, or an undensified SF.

Clause 9. The PCB of clause 1, wherein the additives include a superplasticizer (SP), the SP includes polycarboxylic ether polymer, a polycarboxylate ether, a sulfonated naphthalene formaldehyde, a sulfonated melamine formaldehyde, a lignosulfate, an acrylic polymer, or combinations thereof.

Clause 10. The PCB of clause 1, wherein the additives include an air entraining (AE) agent, the AE agent includes acrylic cement modifiers, natural wood resins, vinsol resins, synthetic detergents, animal and vegetable fats and oils, water-soluble synthetic organic compounds, alkyl benzene sulfonates, or a combination thereof.

Clause 11. The PCB of clause 1, wherein the cement materials comprise ordinary Portland Cement Type I, ordinary Portland Cement Type II, or a combination thereof.

Clause 12. The PCB of clause 1, wherein the PC may include about 75% to about 85% fixed carbon, about 10% to about 20% ash, about 1% to about 3% moisture, and about 0.5% to about 1.5% volatile matter.

Clause 13. The PCB of clause 1, wherein the PC may be pyrolyzed at between about 800 °C and about 900 °C.

Clause 14. A pyrolysis char pave block (PCBP), comprising:
a composition, the composition comprising:
   a dry mixture, comprising
      pyrolysis char (PC); and
      cement materials; and
   a wet mixture, comprising:
      water;
      silica fume (SF); and
      additives;
   wherein the composition is about 25% to about 35% of PC, about 20% to about 60% cement materials, about 0.1% to about 10% SF, and about 1% to about 1.5% additives, by weight.

Clause 15. The PCBP of clause 14, wherein the composition has a water to PC ratio (w/c) of about 0.5 to about 1.5.

Clause 16. The PCBP of clause 14, wherein the cement materials and SF form a binder, and wherein the composition has a PC to binder ratio of about 0.3 to about 0.5.

Clause 17. The PCBP of clause 14, wherein the PCBP has a compressive strength of about 50 MPa to about 60 MPa.

Clause 18. The PCBP of clause 14, wherein the PCBP has a water absorption of about 4% to about 6%.

Clause 19. The PCBP of clause 14, wherein the PCBPs have an average mass loss of about 15 g/m² to about 20 g/m² after the freeze thaw test.

Clause 20. The PCBP of clause 14, wherein the PCBPs have an abrasion value of about 2 mm to about 3 mm.

Clause 21. The PCBP of clause 14, wherein the PCBPs have an abraded volume was about 9 cm³ to about 13 cm³.

Clause 22. The PCBP of clause 14, wherein SF comprises amorphous micronized white silicon dioxide pozzolan, a densified SF, or an undensified SF.

Clause 23. The PCBP of clause 14, wherein the additives include a superplasticizer (SP), the SP includes polycarboxylic ether polymer, a polycarboxylate ether, a sulfonated naphthalene formaldehyde, a sulfonated melamine formaldehyde, a lignosulfate, an acrylic polymer, or combinations thereof.

Clause 24. The PCB of clause 14, wherein the additives include an air entraining (AE) agent, the AE agent includes acrylic cement modifiers, natural wood resins, vinsol resins, synthetic detergents, animal and vegetable fats and oils, water-soluble synthetic organic compounds, alkyl benzene sulfonates, or a combination thereof.

Clause 25. The PCBP of clause 14, wherein the cement materials comprise ordinary Portland Cement Type I, ordinary Portland Cement Type II, or a combination thereof.

Clause 26. The PCBP of clause 14, wherein the PC may include about 75% to about 85% fixed carbon, about 10% to about 20% ash, about 1% to about 3% moisture, and about 0.5% to about 1.5% volatile matter.

Clause 27. The PCBP of clause 14, wherein the PC may be pyrolyzed at between about 800 °C and about 900 °C.

Clause 28. A method of forming a composition, the method comprising:
mixing water and additives to form a wet mixture;
mixing pyrolysis char (PC) and cement materials to form a dry mixture;
mixing the wet mixture and the dry mixture to form a pyrolysis char brick (PCB) mixture;
transferring the PCB mixture to a mold;
pre-pressing the PCB mixture;
initially curing the PCB mixture to for a PCB;
demolding the PCB; and
curing the PCB.

Clause 29. The method of clause 28, further comprising drying the PCBs in an oven.

Clause 30. The method of clause 28, further comprising coating the PCBs in a hydrophobic coating liquid.

Clause 31. The method of clause 28, wherein the composition is about 20% to about 40% of PC, about 20% to about 60% cement materials, about 0.1% to about 10% SF, and about 1% to about 1.5% additives, by weight.

Clause 32. The method of clause 28, wherein the composition has a water to PC ratio (w/c) of about 0.5 to about 1.5.

Clause 33. The method of clause 28, wherein the water and additive are mixed for about 1 minute to about 10 minutes.

Clause 34. The method of clause 28, wherein the PC and cement materials are mixed for about 1 minute to about 5 minutes.

Clause 35. The method of clause 28, wherein the additives include air entraining (AE) agents and superplatisizers (SP).

Clause 36. The method of claim 35, wherein the AE agent includes acrylic cement modifiers, natural wood resins, vinsol resins, synthetic detergents, animal and vegetable fats and oils, water-soluble synthetic organic compounds, alkyl benzene sulfonates, or a combination thereof.

Clause 37. The method of claim 35, wherein the SP includes polycarboxylic ether polymer, a polycarboxylate ether, a sulfonated naphthalene formaldehyde, a sulfonated melamine formaldehyde, a lignosulfate, an acrylic polymer, or combinations thereof.

Clause 38. The method of clause 28, wherein the cement materials and SF form a binder, and wherein the composition has a PC to binder ratio of about 0.3 to about 0.5.

Clause 39. The method of clause 28, wherein the wet mixture and the dry mixture are mixed for about 1 minute to about 10 minutes.

Clause 40. The method of clause 28, wherein the pre-pressing has a pressing pressure of about 4 MPa to about 10 MPa.

Clause 41. The method of clause 28, wherein the pre-pressing has a pressing time of about 30 seconds to about 3 minutes.

Clause 42. The method of clause 28, wherein the temperature of the initial curing is about 20 °C to about 30 °C.

Clause 43. The method of clause 28, wherein the humidity of the initial curing is about 90% to about 100%.

Clause 44. The method of clause 28, wherein the initial curing is about 5 to about 30 days.

Clause 45. The method of clause 28, wherein the PCB is cured in a wet room at a temperature of 24 °C and relative humidity of 95%.

Clause 46. The method of clause 28, wherein the PCB is cured for about 5 days to about 30 days.

Clause 47. The method of clause 28, further comprising air-drying the PCB at a temperature of about 50 °C to about 70 °C

Clause 48. The method of clause 47, wherein the PCB is air-dried for about 20 hours to about 30 hours.

Clause 49. The method of clause 30, wherein the hydrophobic coating includes a styrene acrylate material.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, process operation, process operations, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, process operation, process operations, element, or elements and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

While the foregoing is directed to embodiments of the present disclosure, other and further embodiments of the disclosure may be devised without departing from the basic scope thereof.

What is claimed is:

1. A pyrolysis char brick (PCB), comprising:
a composition, the composition comprising:
a dry mixture, comprising
pyrolysis char (PC); and
cement materials; and
a wet mixture, comprising:
water;
silica fume (SF); and
additives;
wherein the composition is about 20% to about 40% of PC, about 20% to about 60% cement materials, about 0.1% to about 10% SF, and about 1% to about 1.5% additives, by weight.

2. The PCB of claim 1, wherein the composition has a water to PC ratio (w/c) of about 0.5 to about 1.5.

3. The PCB of claim 1, wherein the cement materials and SF form a binder, and wherein the composition has a PC to binder ratio of about 0.3 to about 0.5.

4. The PCB of claim 1, wherein the PCB has a compressive strength of about 35 MPA to about 55 MPa.

5. The PCB of claim 1, wherein the PCB has a density of about 1.0 g/cm³ to about 2.0 g/cm³.

6. A pyrolysis char pave block (PCBP), comprising:
a composition, the composition comprising:
a dry mixture, comprising
pyrolysis char (PC); and
cement materials; and
a wet mixture, comprising:
water;
silica fume (SF); and
additives;
wherein the composition is about 25% to about 35% of PC, about 20% to about 60% cement materials, about 0.1% to about 10% SF, and about 1% to about 1.5% additives, by weight.

7. The PCBP of claim 6, wherein the composition has a water to PC ratio (w/c) of about 0.5 to about 1.5.

8. The PCBP of claim 6, wherein the cement materials and SF form a binder, and wherein the composition has a PC to binder ratio of about 0.3 to about 0.5.

9. The PCBP of claim 6, wherein the PCBP has a compressive strength of about 50 MPa to about 60 MPa.

10. The PCBP of claim 6, wherein the PCBP has a water absorption of about 4% to about 6.

11. A method of forming a composition, the method comprising:
mixing water and additives to form a wet mixture;
mixing pyrolysis char (PC) and cement materials to form a dry mixture;
mixing the wet mixture and the dry mixture to form a pyrolysis char brick (PCB) mixture;
transferring the PCB mixture to a mold;
pre-pressing the PCB mixture;
initially curing the PCB mixture to for a PCB;
demolding the PCB; and
curing the PCB.

12. The method of claim 11, further comprising drying the PCBs in an oven.

13. The method of claim 11, further comprising coating the PCBs in a hydrophobic coating liquid.

14. The method of claim 11, wherein the composition is about 20% to about 40% of PC, about 20% to about 60% cement materials, about 0.1% to about 10% SF, and about 1% to about 1.5% additives, by weight.

15. The method of claim 11, wherein the composition has a water to PC ratio (w/c) of about 0.5 to about 1.5.
